(19) United States
(12) Patent Application Publication
(10) Pub. No.: US 2018/0220173 A1
(43) Pub. Date: Aug. 2, 2018

(54) SIGNAL TO NOISE RATIO MARGIN EQUALIZATION IN SYSTEMS WITH CODED MODULATION

(71) Applicant: Intel Corporation, Santa Clara, CA (US)

(72) Inventors: Rainer Strobel, Munich (DE); Vladimir Oksman, Morganville, NJ (US)

(21) Appl. No.: 15/615,106

(22) Filed: Jun. 6, 2017

Related U.S. Application Data
(60) Provisional application No. 62/452,072, filed on Jan. 30, 2017.

(51) Int. Cl. H04N 21/2383; H04B 1/7117; H04L 25/03

(52) U.S. Cl. CPC H04N 21/2383; H04L 25/03152; H04B 1/7117

(57) ABSTRACT

A method that accomplishes margin equalization utilizing tone ordering is provided. The method includes measuring a respective signal-to-noise-ratio (SNR) margin for each respective tone in a multicarrier channel. A plurality of tone groups is determined by, for each tone group, grouping at least one tone with a relatively high SNR margin with at least one tone with a relatively low SNR margin to form a tone group. Ordering information describing the plurality of tone groups is communicated to a transmitter. The transmitter is configured to load bits for transmission by way of the tones based at least on the ordering information.

### CROSS REFERENCE TO RELATED APPLICATIONS

This application claims the benefit of U.S. Provisional Patent Application Ser. No. 62/452,072 filed on Jan. 30, 2017, which is hereby incorporated herein by reference in its entirety.

### FIELD

The present disclosure relates to the field of communications and modems and in particular to methods and apparatus that improve performance in multicarrier systems.

### BACKGROUND

Communications devices, particularly those that implement digital subscriber line (DSL) technologies (e.g., T1 and xDSL, including SDSL, HDSL, ADSL, etc.), transmit high speed data using analog signals over telephone connections, which are typically copper wire pairs. The connections and equipment are subject to adverse noise. Stationary noise can be easily accounted for by a corresponding bit loading mechanism. However, in the real world noise also has non-stationary components, which are not predictable. One of the common ways of protecting DSL systems against non-stationary, unexpected changes in the incoming noise is a noise margin. Noise margin is usually implemented by intentional reducing the bit loading over subcarriers, so that an unexpected increase of noise does not cause errors. However, a bigger noise margin results in a lower bit rate and a reduction in system performance.

### BRIEF DESCRIPTION OF THE DRAWINGS

Some examples of circuits, apparatuses and/or methods will be described in the following by way of example only. In this context, reference will be made to the accompanying Figures.

FIG. 1 illustrates a block diagram of a DSL DMT transceiver system.

FIG. 2 illustrates a block diagram of an exemplary DSL DMT transmitter and an exemplary DSL DMT receiver.

FIG. 3 illustrates a flowchart that outlines an exemplary method for determining an order of tones that accomplishes signal to noise ratio (SNR) margin equalization.

FIG. 4 illustrates a flowchart that outlines an exemplary method for dynamically determining an order of tones that accomplishes SNR margin equalization.

FIG. 5 and FIG. 6 illustrate simulation results for tone ordering to equalize SNR margin as described herein.

### DETAILED DESCRIPTION

The present disclosure will now be described with reference to the attached figures, wherein like reference numerals are used to refer to like elements throughout, and wherein the illustrated structures and devices are not necessarily drawn to scale. As utilized herein, terms “module”, “component,” “system,” “circuit,” “element,” “slice,” “circuitry,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include one or more processors therein to execute software and/or firmware that confer(s), at least in part, the functionality of the electronic components.

It will be understood that when an element is referred to as being “electrically connected” or “electrically coupled” to another element, it can be physically connected or coupled to the other element such that current and/or electromagnetic radiation can flow along a conductive path formed by the elements. Intervening conductive, inductive, or capacitive elements may be present between the element and the other element when the elements are described as being electrically coupled or connected to one another. Further, when electrically coupled or connected to one another, one element may be capable of inducing a voltage or current flow or propagation of an electro-magnetic wave in the other element without physical contact or intervening components. Further, when a voltage, current, or signal is referred to as being “applied” to an element, the voltage, current, or signal may be conducted to the element by way of a physical connection or by way of capacitive, electro-magnetic, or inductive coupling that does not involve a physical connection.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

In the following description, a plurality of details is set forth to provide a more thorough explanation of the embodiments of the present disclosure. However, it will be apparent to one skilled in the art that embodiments of the present disclosure may be practiced without these specific details. In other instances, well-known structures and devices are shown in block diagram form rather than in detail in order to avoid obscuring embodiments of the present disclosure. In addition, features of the different embodiments described hereinafter may be combined with each other, unless specifically noted otherwise.

The noise margin is minimized in order to minimize the loss of the bit rate while keeping protection of the system against pre-defined unexpected increases in noise. In DSL systems various forward error correction coding techniques (including also convolutional coding and other coding types that make soft decisions) have been developed and employed in the past. Typically, in forward error correction coding, at the transmitter, data bits are encoded by adding redundancy bits systematically to the data bits so that, normally, only predetermined transitions from one sequential group of bits (corresponding to a symbol, or baud) to another are allowed. There is an inherent correlation between these redundant bits over consecutive bauds. At the receiver, each baud is tentatively decoded and then analyzed based on past history, and the decoded bits are corrected, if necessary. Certain forward error correction techniques, such as those that use soft decisions, can utilize higher SNR on some bits to improve decoding of other bits, those with lower SNR. This way the overall noise margin can be equalized and minimized.

Multicarrier systems such as xDSL and G.fast select the number of bits modulated on each subcarrier or tone with respect to the signal-to-noise ratio (SNR) on each subcarrier. The sequence in which bits are allocated across the subcarriers in symbol is referred to as “tone ordering.” For the purposes of this description, the term “tone” will be used interchangeably with the term “subcarrier” and these terms should be interpreted as having the same meaning. Because channel conditions may cause some tones to provide higher or lower SNR, more bits may be allocated to tones with higher SNR while fewer bits are allocated to tones that provide lower SNR. To improve stability and achieve a certain target bit error rate, the selected bit allocation includes some SNR margin (i.e., the bit loading is computed for an SNR that is less than the actual SNR on a particular tone by a value of an assigned noise margin such that:

SNR (bit loading)=SNR (actual)−noise margin

To ensure stable operation, the bit allocation is selected to guarantee that the target SNR margin is met. The SNR margin as between all the subcarriers should be equal. Because the number of bits loaded per subcarrier is an integer number, while the SNR may have any value, the target SNR margin may not be achieved exactly.

In current xDSL systems, margin equalization is implemented by a receiver controlled transmit power adjustment (fine gains). This is not possible in G.fast downstream, because a receiver-requested transmit power change may cause transmit power spectral density (PSD) violations due to the downstream precoding, which causes dependencies between the transmitted PSDs on each of the lines in the vectored group. Therefore, current G.fast systems do not allow noise margin equalization in the downstream direction.

In current xDSL and G.fast systems, the tone ordering for forward error correction is a static setting which is configured once during link training. Usually, the tones are processed in the natural tone order from the first to the last tone or interleaving of the tones is applied. This static setting of tone ordering is sufficient for current xDSL systems because they can employ a fine gain mechanism to equalize the noise margin. For systems like G.fast, in which fine gains are not always applicable, dynamic change of tone ordering as presented herein may be beneficial.

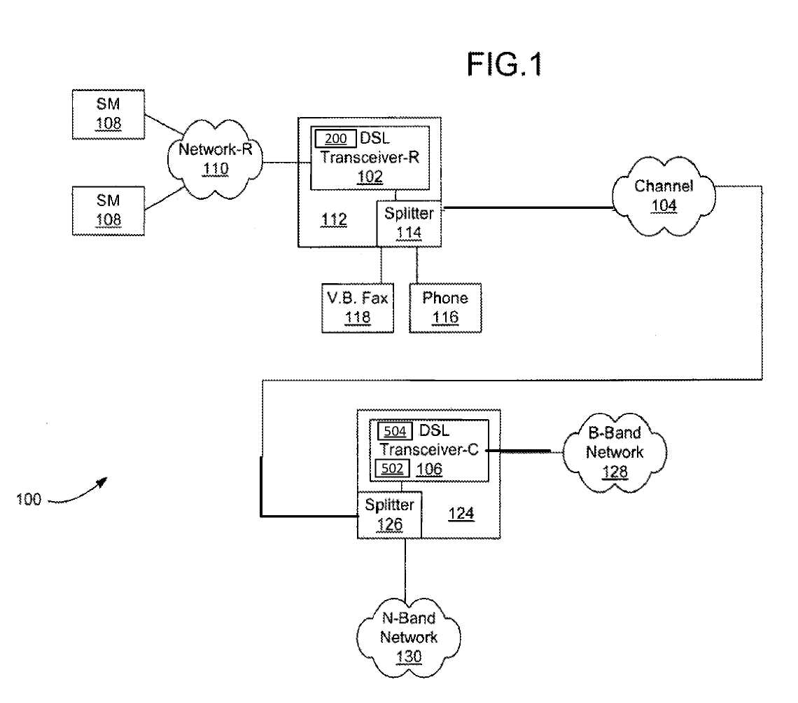

FIG. 1 shows a block diagram of a digital subscriber line (DSL) discrete multi-tone (DMT) transceiver system 100 showing the basic functional blocks and interfaces. The DSL transceiver system includes a DSL remote transceiver (Transceiver-R) 102, a channel 104, and a DSL central transceiver (Transceiver-C) 106. The Transceiver-R 102 is typically housed in a DSL DMT modem 112. The Transceiver-C 106 is typically housed in a Digital Subscriber Line Access Multiplexer (DSLAM) 124 located at a central office or in street cabinets in xDSL systems and in distribution points (DPs) in G.fast systems. The DSL DMT transceiver system 100 shows a transmission system and method for data transport. Remote power feeding, which may be provided by the Transceiver-C, 106 is not shown.

In the DSL DMT transceiver system 100, a DSL circuit connects the Transceiver-R 102 and the Transceiver-C 106 on each end of a twisted-pair telephone line, creating three information channels: a high speed downstream channel, a medium speed duplex channel, and a plain old telephone service (POTS) channel. The POTS channel is split off from the digital modems by splitters, thus guaranteeing uninterrupted POTS.

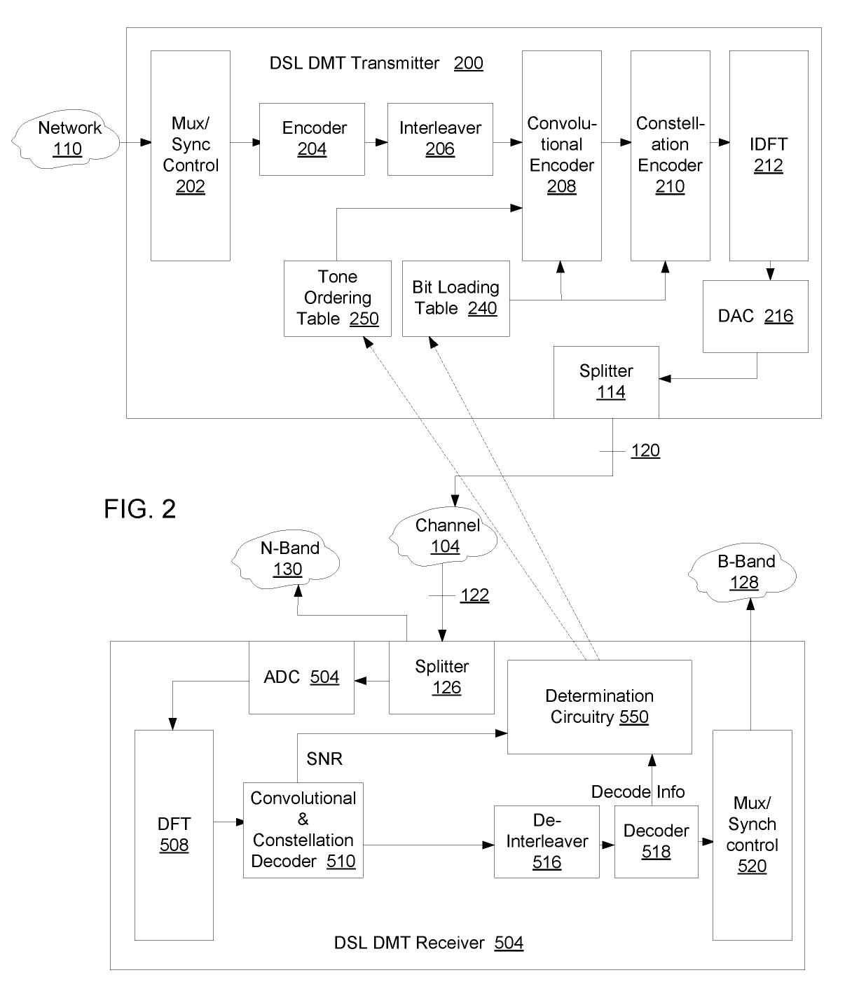

The Transceiver-R 102 is typically located at a customer's premise and the Transceiver-C 106 is typically located at a telephone company's central office or remote location, such as a street cabinet for xDSL systems and a DP for G.fast. The Transceiver-C 106 acts as a master to some functions of the Transceiver-R 102. In a typical application, transmitter and receiver components will be incorporated into the same device so that each is capable of transmitting and receiving data. As shown in FIG. 2, a DSL DMT transmitter 200 and a DSL DMT receiver 504, are configured to communicate with one another by way of the channel 104.

The Transceiver-R 102 includes a DMT transmitter 200, described in detail below and shown in FIG. 2. For ease in describing the DSL DMT transceiver system 100, the detailed description is provided from the perspective of passing information from the transmitter in the Transceiver-R 102 to the receiver in the Transceiver-C 106. An analogous analysis process occurs during to the transmission of information from the Transceiver-C 106 to the Transceiver-R 102. The DMT modem 112 may also contain a splitter 114 and other components not related to the present disclosure.

The input to the Transceiver-R 102 may be a remote network (Network-R) 110. The remote network 110 may include service modules (SMs) 108. The service modules 108 may be personal computers, servers, routers, and many other devices known to those skilled in the art. A standard phone 116, a voice band facsimile (VB. Fax) 118, and an ISDN device may be connected to the splitter 114. The splitter 114 contains filters that separate high frequency DSL signals from voice band signals such as the standard phone 116, the facsimile 118, and the ISDN device.

The transmitter 200 within the Transceiver-R 102, processes the service modules 108 and remote network 110 signals for transmission to the receiver 502 within the Transceiver-C 106, via the channel 104. The transmitter 200 processing includes dynamic tone ordering for signal-to-noise ratio (SNR) margin equalization which will be described in more detail below.

The receiver 502 in the DSL Transceiver-C (shown in detail in FIG. 2) de-processes the signal and passes the de-processed signals to the Broadband (B-Band) Network 128 and the narrowband (N-Band) network 130. The Transceiver-C 106 is housed in the DSLAM 124 along With a DSLAM splitter 126 and other components not related to the present disclosure. The receiver 502 is housed in the Transceiver-C 106, and performs functions that determine a tone order used by the DMT Transmitter 200 in tone ordering for SNR margin equalization which will be described in more detail below.

FIG. 2 is a block diagram of an exemplary DSL DMT transmitter 200 that resides in the Transceiver-R 102 and also in the Transceiver-C 106 of FIG. 1. Selected basic functional blocks of the transmitter 200 are shown in FIG. 2. It should be noted that the components shown in FIG. 2 are not all required to construct a transmitter. Instead, the components are models for facilitating the construction of DMT signal waveforms. Those waveforms may be constructed in a variety of ways including by hardware, software, and firmware. The transmitter 200 receives input(s) from service modules or remote network(s) 110. A multiplexor synchronous control element (Mux/Sync Control) 202 accepts the inputs and converts the inputs into multiplexed and synchronized data frames (mux data frames). The multiplexor synchronous control element 202 generates the mux data frames at some nominal baud rate.

The binary data stream(s) which is the mux data frame output of the multiplexor synchronous control element 202 passes to convolutional encoder 208 after processing by an encoder 204 that performs forward error correction (FEC) on the binary data stream (e.g., a Reed-Solomon encoder) and outputs codewords. The FECs are applied in the encoder 204 to the binary data streams without reference to any framing or symbol synchronizations. Decoding in the receiver 502 can likewise be performed independent of symbol synchronization. An interleaver 206 convolutionally interleaves the codewords output by the encoder 204. The binary data stream is also processed by cyclical redundancy checks (CRCs) that are not shown in FIG. 2. The output of the interleaver 206 is formatted by the convolutional encoder 208 into a series of frames generated at the DMT symbol rate. Note that a codeword may span more than one DMT symbol.

The convolutional encoder 208 transforms the data stream from the interleaver 206 into a sequence of tone ordered data frames to be loaded on symbols. The convolutional encoder 208 first generates additional bits to aid in decoding and adds the additional bits to the bit stream. The convolutional encoder 208 loads bits from the augmented bitstream into tones based on information stored in a bit loading table 240 and a tone ordering table 250. The bit loading table 240 specifies a number of bits that should be loaded into each tone, based on the target SNR margin. The tone ordering table 250 specifies an order in which tones should be loaded with bits. For example, the convolutional encoder 208 reads the tone ordering table to determine that the next tone to be loaded is tone number 153. The convolutional encoder 208 reads the bit loading table 240 to determine that 5 bits should be loaded onto tone 153. The convolutional encoder 208 then loads the next 5 bits of the augmented data stream onto tone 153.

The various elements referred to herein as “tables” such as the bit loading table 240 and the tone ordering table 250 may be any system, computer program, hardware device, memory element, or logic device that organizes information in a readily retrievable manner. The tone ordering table 250 communicates a specific arrangement of tones into tone groups. The bit loading table 240 specifies number of bits per tone. As will be described in more detail below, the tone ordering table 250 and the bit loading table 240 are determined by determination circuitry 550 in the receiver 502 and sent to the transmitter 200 according to a protocol defined by ITU standards. The tone ordering table 250 is determined, by the receiver, with data representing a particular tone order identified by an ordered list of tone numbers or indices. The tone order is based on a tone grouping that is performed by the receiver 504. The bit loading table 240 is also determined, by the receiver 504, with data representing a number of bits to be allocated to each tone. The convolutional encoder 208 assigns bits from the augmented bitstream to the tones in the order specified by the tone ordering table 250 with the number of bits assigned to them in the bit loading table 240.

The tone ordered data symbols are passed to a constellation encoder 210. The constellation encoder 210 reads the bit loading of each tone to determine a constellation shape to use. The constellation encoder 210 converts the tone ordered data frames into a set of coordinates of coded constellation points for each of the DMT tones. The constellational encoder 210 may be similar to a Quadrature Amplitude Modulation (QAM) encoder.

The coded constellation points of the DMT tones from the constellation encoder 210 are passed on to an Inverse Discrete Fourier Transformer (IDFT) 212. The IDFT 212 converts these constellation points to output time-domain samples, which are passed to a digital-to-analog converter (DAC) 216. The DAC 216 and associated analog processing blocks (not shown) construct a continuous transmit voltage waveform corresponding to the discrete digital input samples from the IDFT 212. The analog signal passes through the splitter 114 and the loop interface remote terminal end 120 and enters the channel 104.

FIG. 2 also illustrates a block diagram of the exemplary DSL DMT receiver 502 that resides in the Transceiver-R 102 and the Transceiver-C 106 of FIG. 1. The receiver 502 receives an input signal at a splitter 126 from the channel 104 and through the loop interface central office end 122. The signal includes narrowband signals that are split by the splitter 126 and sent to the narrow band network 130. The broadband portion of the signal from the channel 104 is processed by an analog-to-digital (ADC) converter 504 and is demodulated by a Discrete Fourier Transformer (DFT) element 508. The DFT element 508 passes the demodulated signal to a convolutional and constellation decoder 510. The convolutional and constellation decoder 510 may include a Viterbi decoder. The output bitstream of the convolutional and constellation decoder 510 is processed by a de-interleaver 516 and FEC decoder 518 (e.g., a Reed-Solomon decoder). A multiplexor synchronous control element 520 passes the de-interleaved and FEC decoded signal to the broadband network 128. There may be additional components involved in processing signals beyond those shown in the FIGS. 1 and 2.

Now that the overall architecture and functioning of the transmitter 200 and receiver 504 have been generally described, the technique utilized by the determination circuitry 550 to determine the tone ordering table 250 and the bit loading table 240 will be described in the context of G.fast and xDSL systems. The tone ordering techniques described herein are also applicable to other DSL systems. While in the present disclosure, a single circuitry 550 is described as determining both tone order and bit loading, in some examples, different, separate circuitry is used for tone ordering and bit loading, respectively. Disclosed herein are apparatus and methods that perform margin equalization, based on the tone ordering, which is the order in which the individual subcarriers are processed by forward error correction (e.g., an encoder). The tone ordering may be adjusted based to changing channel and noise conditions. A protocol for such dynamic changes of tone ordering will now be described.

G.fast and xDSL systems select the QAM constellation size of the modulator with respect to the SNR on each carrier or tone of the multi-carrier transmission. While the SNR may have any value, depending on the channel and noise conditions, the constellation size can be changed in one bit steps, e.g., between a 1 bit constellation (2QAM) and a 12 bit constellation (4096QAM).

The capacity of a carrier k is given, e.g., by

$$\begin{matrix}EQ ( 1 ) & \\ {C}^{( k )} = {log}_{2} ( 1 + \frac{SNR}{Γ} ) & ( 1 )\end{matrix}$$

for a certain SNR SNR and an SNR gap r to meet the bit error rate target. To meet the bit error rate targets with QAM constellations, the constellation size b^{(k)} is selected to be smaller than the capacity, e.g.,

$${b}^{( k )} = min ( ⌊ {log}_{2} ( 1 + \frac{SNR}{Γ} ) ⌋ , {b}_{max} ) . \qquad EQ ( 2 )$$

The floor rounding ensures that the target bit error rate is met, but also causes an ½ bit capacity loss on average. Further, the scheme causes some SNR margin, up to 3 dB, due to the floor rounding.

G.fast and xDSL use forward error correction (Reed-Solomon) coding and Trellis coding to increase data rates and reduce bit error rates. G.fast uses two error correction codes, a convolutional code (trellis code) as an inner code, which operates on pairs of subcarriers (4D wei code) and an outer Reed-Solomon block code, which is used to correct burst errors due to Viberbi decoding and other bit errors which remain un-corrected from the Viterbi decoder. The following description focuses on the described combination of Trellis and Reed-Solomon coding schemes, but the described techniques are not limited to that. The tone ordering techniques described herein may be applied to more advanced coding schemes like LDPC coded modulation (LCM), also, as well as to other codes that use soft-decision mechanisms.

There are different strategies to define a tone ordering table, e.g., natural ordering (based on tone indices), interleaved tone ordering, or an optimized tone ordering may be derived as described below. Natural tone ordering means that the o^{(k)}=k is selected, while for interleaving with Nᵢ carriers, is

$${o}^{( k )} = mod ( k - 1 , {N}_{i} ) {N}_{i} + ⌈ \frac{k}{{N}_{i}} ⌉$$

used. Either of these methods may be used in the existing transceivers for static tone ordering.

For the optimized tone ordering described herein, the margin is equalized using the encoding order. This can be done by grouping one or more tones with higher margin with one or more tones with lower margin. Assuming grouping of one low-margin tone and on high-margin tone, and that there is a target margin [symbol] , to achieve the target bit error rate with the given constellation on carrier k, the SNR SNR_{req b}_{^{(k)}} is required. For the actual SNR SNR^{(k)} this gives the actual margin [symbol] according to

$${γ}_{m}^{( k )} = \frac{{SNR}^{( k )}}{{SNR}_{req} {\hat{b}}^{( k )}} \qquad EQ ( 3 )$$

for carrier k.

One way of implementing margin equalization is for the determination circuitry 550 to select the tone ordering o according to

$${o}^{( k )} = \{ \begin{matrix}arg {min}_{i : i ∉ {o}_{1 , … , {o}^{( k - 1 )}}} {γ}_{m}^{( i )} & for k even \\ arg {max}_{i : i ∉ {o}_{1 , … , {o}^{( k - 1 )}}} {γ}_{m}^{( i )} & for k odd .\end{matrix} \qquad EQ ( 4 )$$

The above tone ordering pairs an “even numbered” tone (e.g., tones with even indices) having the minimum SNR with an “odd numbered” tone (e.g., tones with odd indices) having the maximum SNR. The corresponding minimum SNR margin per tone group (e.g, a pair of tones), which gives an upper bound on the actual BER is

$${γ}_{m , min} = {min}_{i ∈ 1 , … , T , i odd} \sqrt{{γ}_{m}^{( {o}_{i} )} {γ}_{m}^{( {o}_{i + 1} )}} . \qquad EQ ( 5 )$$

The bit allocation may be selected by the determination circuitry 550 according to the configured SNR margin per tone group, allowing an increase of the bit allocation of approximately ½ bits. The determination circuitry 550 provides the determined tone order and bit allocation to a transmitter (502 in FIG. 1) in the DSL Transceiver-C (106 in FIG. 1). The transmitter 502 transmits the tone order and bit allocation to the DSL Transceiver-R (102 in FIG. 1). The transmitter 200 of the transceiver 102 applies the tone ordering table 250 and the bit loading table 240 to establish the transmitted tone order and bit allocation.

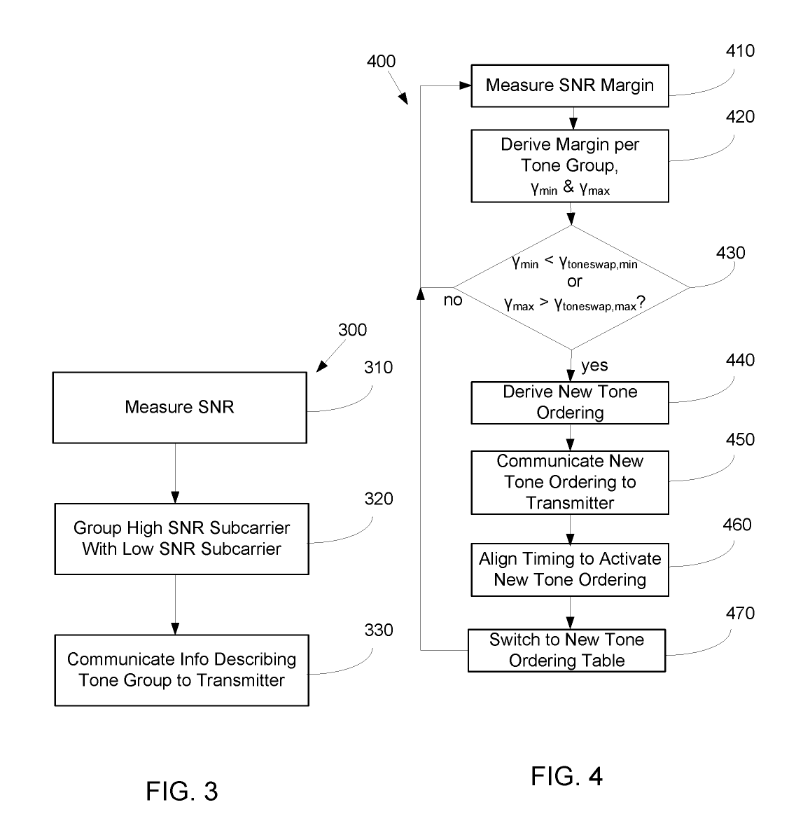

FIG. 3 illustrates a flow diagram outlining an exemplary method 300 that may be used by the determination circuitry 550 of FIG. 2 in constructing the tone ordering table 250 and the bit loading table 240. Recall the tone ordering table 250 and the bit loading table 240 are used herein as a shorthand notation for any form of stored information or data, such as a table or list or matrix, that is constructed or compiled by the determination circuitry 550 to communicate an arrangement or grouping of tones and/or bit allocations per tone for use by the transmitter in allocating bits. The tone ordering table 250 may be a list of tone indices in the order in which the transmitter shall load bits.

The method 300 includes, at 310, measuring a respective signal-to-noise-ratio (SNR) margin for each respective tone in a multicarrier channel. The measured SNR margin for each tone may be obtained from the decoder 510 in FIG. 2. At 320, at least one tone with a relatively high SNR margin is grouped with at least one tone with a relatively low SNR margin to form a tone group. The number of tones in a group and/or the number of bits per group is selected based on information about the encoding/decoding scheme that is in use (e.g., codeword length). Ordering information describing the tone group is communicated to a transmitter at 330. The transmitter loads bits for transmission by way of the subcarriers in the multicarrier channel based at least on the ordering information.

In one example, the method includes, until all tones have been grouped: selecting, from tones having even indices, a first tone having a minimum SNR margin; selecting from tones having odd indices, a second tone having a maximum SNR margin; grouping the first tone with the second tone to form a new tone group; and eliminating from consideration the first tone and the second tone.

In one example, for each tone in the tone group, a number of bits allocated to the tone is determined based at least on the SNR margin for the tone. Allocation information describing the determined number of bits allocated to each tone is communicated to the transmitter. The transmitter loads bits for transmission by way of the tones in the multicarrier channel based at least on the allocation information. In one example, the method includes forming a plurality of tone groups in a manner that equalizes a group SNR margin for each tone group. The group SNR for each group may be determined based at least on a square root of a product of the SNR for a first tone in the tone group and the SNR for a second tone in the tone group.

Channel conditions are continuously changing, meaning that the SNR margin on each subcarrier or tone will also be changing. This could result in degraded SNR margin equalization. To maintain the gain in SNR margin, dynamic adjustment of the tone ordering table 250 and the bit loading table 240 is performed by the determination circuitry 550 during an active link. This is to be contrasted with some systems in which tone ordering is selected once during the link training and cannot be changed, without a new link training. DSL and G.fast systems are capable of making dynamic changes to certain transmission parameters such as constellation size or transmit power per carrier. There are two such methods implemented in G.fast, SRA (seamless rate adaptation), which changes the data rate and bit swap, which is used for margin equalization, and does not change data rate.

Due to changing channel conditions, in one example, the determination circuitry 550 continuously or periodically monitors the SNR margin of the subcarriers during an active link or normal operation. When some threshold based at least on SNR margin is met, the determination circuitry 550 is configured to determine a second tone grouping and communicate information describing the new tone groups to the transmitter.

A change of tone ordering has no effect on the data rate. Therefore, changing tone ordering is similar to a bit swap operation and may be combined with bit-swap. In one example, the triggering criteria for a change of tone ordering is the minimum margin per tone group according to Eq. (5). When the minimum group margin is below a lower bound [symbol] _{,min}< [symbol] _{,min} or the maximum group margin is above an upper bound [symbol] _{,max}< [symbol] _{,max}, the determination circuitry 550 is triggered to change the tone ordering. Herein γ_{m,max} is given by

$${γ}_{m , max} = {max}_{i ∈ 1 , … , T , i odd} \sqrt{{γ}_{m}^{( {o}_{i} )} {γ}_{m}^{( {o}_{i + 1} )}} . \qquad ( 6 )$$

FIG. 4 illustrates a flow diagram outlining a method 400 that may be used by the determination circuitry 550 to perform dynamic tone ordering. The method includes, after communicating initial ordering information to the transmitter, measuring a second SNR margin for each tone at 410. At 420, a group SNR margin for each tone group is determined based at least on the second SNR margin for each tone. At 430, the method includes identifying, from amongst the group SNR margins for the tone groups, a minimum group SNR margin γₘᵢₙ and a maximum group SNR margin γₘₐₓ. The minimum group SNR margin is compared to a minimum threshold γ_{toneswap,min} and the maximum group SNR margin is compared to a maximum threshold γ_{toneswap,max}. When the minimum group SNR margin is less than the minimum threshold or the maximum group SNR margin is more than the maximum threshold, at 440 the method includes regrouping the tones into a second set of tone groups based on the second SNR for each subcarrier. The re-grouping may include performing the steps outlined in FIG. 3 based on the second SNR values. Otherwise the tone groups are maintained and the method returns to 410 and continues to measure the SNR margin for each subcarrier. At 450, the method includes communicating ordering information describing the second set of tone groups to the transmitter. At 460 timing is aligned to activate new tone ordering and at 470 the new tone ordering is used by the transmitter.

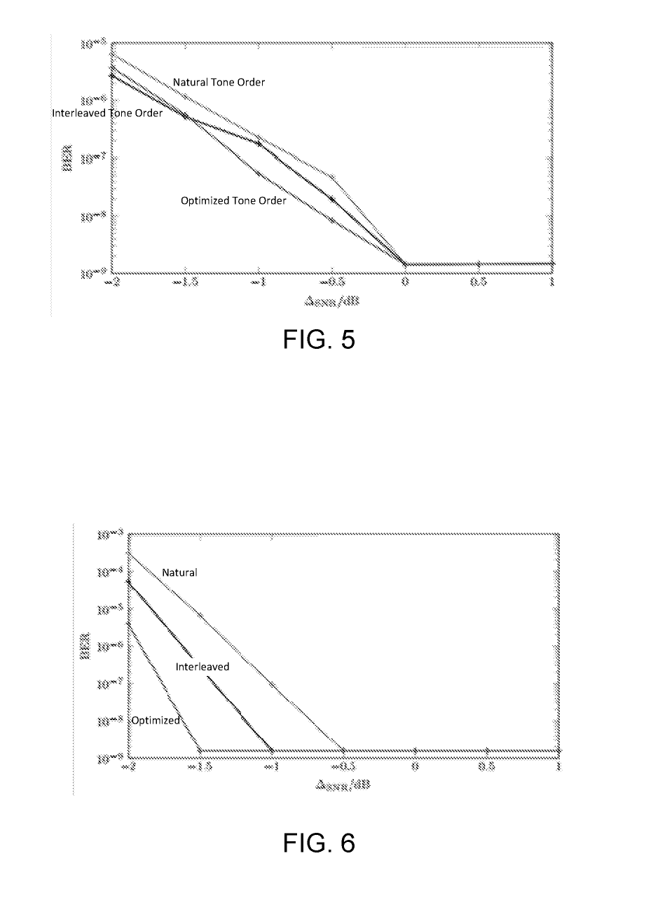

FIG. 5 and FIG. 6 demonstrate the effect of optimized tone ordering for the example of a G.fast system, operating at a target bit error rate of to 10⁻⁷ with trellis coding, only or with trellis and Reed-Solomon coding. The bit allocation is selected such that the target bit error rate is achieved with [symbol] =0 dB margin. With reduced SNR margin, the bit error rate increases. FIG. 5 shows the bit error rates for different settings of the target margin [symbol] . The natural tone order shows only a very small margin equalization effect around the target bit error rate of to 10⁻⁷. With interleaved tone ordering, the target bit error rate is achieved already with −0.7 dB SNR margin. With the proposed, optimized tone ordering scheme it further improves towards −1.2 dB.

For the combined Reed-Solomon and trellis coding scheme, as shown in FIG. 6, the performance improvements for optimized tone ordering are even higher. The target bit error rate is achieved with −1.7 dB target SNR margin.

While the methods are illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases.

It can be seen from the foregoing description that the disclosed dynamic tone ordering techniques accomplish margin equalization by ordering tones into groups having similar group SNR margin.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Example 1 is a method, including: measuring a respective signal-to-noise-ratio (SNR) margin for each respective tone in a multicarrier channel; determining a plurality of tone groups by, for each tone group, grouping at least one tone with a relatively high SNR margin with at least one tone with a relatively low SNR margin to form a tone group; and communicating ordering information describing the plurality of tone groups to a transmitter, wherein the transmitter is configured to load bits for transmission by way of the tones based at least on the ordering information.

Example 2 includes the subject matter of example 1, including or omitting optional elements, wherein the tones are assigned respective integer tone indices and the grouping includes, until all tones have been grouped: selecting, from tones having even indices, first tone having a minimum SNR margin; selecting, from tones having odd indices, a second tone having a maximum SNR margin; grouping the first tone with the second tone to form a new tone group; and eliminating the first tone and the second tone from consideration.

Example 3 includes the subject matter of example 1, including or omitting optional elements, further including: for each tone in each tone group, determining a number of bits allocated to the tone based at least on the SNR margin for the tone; and communicating allocation information describing the determined number of bits allocated to each tone to the transmitter, wherein the transmitter loads bits for transmission by way of the tones based at least on the allocation information.

Example 4 includes the subject matter of examples 1-3, including or omitting optional elements, further including forming the plurality of tone groups in a manner that equalizes a group SNR margin amongst the tone groups.

Example 5 includes the subject matter of example 4, including or omitting optional elements, further including determining the group SNR for each group based at least on a square root of a product of the SNR margin for a first tone in the tone group and the SNR margin for a second tone in the tone group.

Example 6 includes the subject matter of examples 1-3, including or omitting optional elements, further including, after communicating the ordering information to the transmitter: measuring a second SNR margin for each tone; and when a threshold based at least on SNR margin is met: determining a second plurality of tone groups by, for each tone group, grouping at least one tone with a relatively high second SNR margin with at least one tone with a relatively low second SNR margin to form a new tone group; and communicating second ordering information describing the plurality of new tone groups to the transmitter.

Example 7 includes the subject matter of example 6, including or omitting optional elements, further including determining whether the threshold is met by: determining a group SNR margin for each tone group based at least on the second SNR margin for each tone; identifying, from amongst the group SNR margins for the tone groups, a minimum group SNR margin and a maximum group SNR margin; comparing the minimum group SNR margin to a minimum threshold; determining that the threshold has been met when the minimum group SNR margin is less than the minimum threshold; comparing the maximum group SNR margin to a maximum threshold; and determining that the threshold has been met when the maximum group SNR margin is less than the maximum threshold.

Example 8 is a machine readable medium including code, when executed, to cause a machine to perform the method of any one of examples 1-7.

Example 9 is a transceiver, including: a receiver including determination circuitry configured to: measure a respective signal-to-noise-ratio (SNR) margin for each respective tone in a multicarrier channel; determine a plurality of tone groups by, for each tone group, grouping at least one tone with a relatively high SNR margin with at least one tone with a relatively low SNR margin to form a tone group; and a transmitter configured to transmit tone ordering information describing the plurality of tone groups to a second transceiver, wherein the second transceiver is configured to load bits for transmission to the receiver based at least on the ordering information.

Example 10 includes the subject matter of example 1, including or omitting optional elements, wherein the tones are assigned respective integer tone indices and the determination circuitry is configured to, until all tones have been grouped: select, from tones having even indices, first tone having a minimum SNR margin; select, from tones having odd indices, an second tone having a maximum SNR margin; group the first tone with the second tone to form a new tone group; and eliminate the first tone and the second tone from consideration.

Example 11 includes the subject matter of example 9, including or omitting optional elements, wherein: the determination circuitry is further configured to for each tone in each tone group, determine a number of bits allocated to the tone based at least on the SNR margin for the tone; and the transmitter is configured to transmit allocation information describing the determined number of bits allocated to each tone to the transceiver, wherein the transceiver loads bits for transmission to the receiver by way of the tones based at least on the allocation information.

Example 12 includes the subject matter of examples 9-11, including or omitting optional elements, wherein the determination circuitry is further configured to form the plurality of tone groups in a manner that equalizes a group SNR margin for each tone group.

Example 13 includes the subject matter of example 12, including or omitting optional elements, wherein the determination circuitry is further configured to determine the group SNR for each group based at least on a square root of a product of the SNR margin for a first tone in the tone group and the SNR margin for a second tone in the tone group.

Example 14 includes the subject matter of examples 9-11, including or omitting optional elements, wherein the determination circuitry is further configured to, after the transmitter transmits the tone ordering information to the transmitter: measure a second SNR margin for each tone; and when a threshold based at least on SNR margin is met: determine a second plurality of tone groups by, for each tone group, grouping at least one tone with a relatively high second SNR margin with at least one tone with a relatively low second SNR margin to form a new tone group; communicate second ordering information describing the plurality of new tone groups to the transmitter for transmission to the transceiver.

Example 15 includes the subject matter of examples 9-11, including or omitting optional elements, wherein the determination circuitry is further configured to determine whether the threshold is met by: determining a group SNR margin for each tone group based at least on the second SNR margin for each tone; identifying, from amongst the group SNR margins for the tone groups, a minimum group SNR margin and a maximum group SNR margin; comparing the minimum group SNR margin to a minimum threshold; determining that the threshold has been met when the minimum group SNR margin is less than the minimum threshold; comparing the maximum group SNR margin to a maximum threshold; and determining that the threshold has been met when the maximum group SNR margin is less than the maximum threshold.

Example 16 is computer readable media having computer-executable instructions stored thereon that, when executed by a processor, cause the processor to perform corresponding functions, the instructions including instructions for: measuring a respective signal-to-noise-ratio (SNR) margin for each respective tone in a multicarrier channel; determining a plurality of tone groups by, for each tone group, grouping at least one tone with a relatively high SNR margin with at least one tone with a relatively low SNR margin to form a tone group; and communicating ordering information describing the plurality of tone groups to a transmitter, wherein the transmitter is configured to load bits for transmission by way of the tones based at least on the ordering information.

Example 17 includes the subject matter of example 16, including or omitting optional elements, wherein the tones are assigned respective integer tone indices and wherein the instructions for grouping include instructions for, until all tones have been grouped: selecting, from tones having even indices, first tone having a minimum SNR margin; selecting, from tones having odd indices, an second tone having a maximum SNR margin; grouping the first tone with the second tone to form a new tone group; and eliminating the first tone and the second tone from consideration.

Example 18 includes the subject matter of example 16, including or omitting optional elements, wherein the instructions further include instructions for: for each tone in each tone group, determining a number of bits allocated to the tone based at least on the SNR margin for the tone; and communicating allocation information describing the determined number of bits allocated to each tone to the transmitter, wherein the transmitter loads bits for transmission by way of the tones based at least on the allocation information.

Example 19 includes the subject matter of examples 16-18, including or omitting optional elements, wherein the instructions include instructions for forming the plurality of tone groups in a manner that equalizes a group SNR margin for each tone group.

Example 20 includes the subject matter of example 19, including or omitting optional elements, wherein the instructions include instructions for determining the group SNR for each group based at least on a square root of a product of the SNR margin for a first tone in the tone group and the SNR margin for a second tone in the tone group.

Example 21 includes the subject matter of examples 16-18, including or omitting optional elements, wherein the instructions include instructions for, after communicating the ordering information to the transmitter: measuring a second SNR margin for each tone; and when a threshold based at least on SNR margin is met: determining a second plurality of tone groups by, for each tone group, grouping at least one tone with a relatively high second SNR margin with at least one tone with a relatively low second SNR margin to form a new tone group; and communicating second ordering information describing the plurality of new tone groups to the transmitter.

Example 22 includes the subject matter of example 21, including or omitting optional elements, wherein the instructions for determining whether the threshold is met include instructions for: determining a group SNR margin for each tone group based at least on the second SNR margin for each tone; identifying, from amongst the group SNR margins for the tone groups, a minimum group SNR margin and a maximum group SNR margin; comparing the minimum group SNR margin to a minimum threshold; determining that the threshold has been met when the minimum group SNR margin is less than the minimum threshold; comparing the maximum group SNR margin to a maximum threshold; and determining that the threshold has been met when the maximum group SNR margin is less than the maximum threshold.

Example 23 is an apparatus configured to determine tone groups for a transceiver, including: means for measuring a respective signal-to-noise-ratio (SNR) margin for each respective tone in a multicarrier channel; means for determining a plurality of tone groups by, for each tone group, grouping at least one tone with a relatively high SNR margin with at least one tone with a relatively low SNR margin to form a tone group; and means for communicating ordering information describing the plurality of tone groups to a transmitter, wherein the transmitter is configured to load bits for transmission by way of the tones based at least on the ordering information.

Example 24 includes the subject matter of example 23, including or omitting optional elements, wherein the tones are assigned respective integer tone indices and the means for grouping is configured to, until all tones have been grouped: select, from tones having even indices, first tone having a minimum SNR margin; select, from tones having odd indices, a second tone having a maximum SNR margin; group the first tone with the second tone to form a new tone group; and eliminate the first tone and the second tone from consideration.

Example 25 includes the subject matter of example 23, including or omitting optional elements, further including: means for determining, for each tone in each tone group, a number of bits allocated to the tone based at least on the SNR margin for the tone; and means for communicating allocation information describing the determined number of bits allocated to each tone to the transmitter, wherein the transmitter loads bits for transmission by way of the tones based at least on the allocation information.

Example 26 is machine-readable storage including machine-readable instructions, when executed, to implement a method or realize an apparatus as recited in any preceding example.

Example 27 is an apparatus including means to perform a method as recited in any preceding example.

Various illustrative logics, logical blocks, modules, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application.

1. A method, comprising:
measuring a respective signal-to-noise-ratio (SNR) margin for each respective tone in a multicarrier channel;
determining a plurality of tone groups by, for each tone group, grouping at least one tone with a relatively high SNR margin with at least one tone with a relatively low SNR margin to form a tone group; and
communicating ordering information describing the plurality of tone groups to a transmitter, wherein the transmitter is configured to load bits for transmission by way of the tones based at least on the ordering information.

2. The method of claim 1, wherein the tones are assigned respective integer tone indices and the grouping comprises, until all tones have been grouped:
selecting, from tones having even indices, first tone having a minimum SNR margin;
selecting, from tones having odd indices, a second tone having a maximum SNR margin;
grouping the first tone with the second tone to form a new tone group; and
eliminating the first tone and the second tone from consideration.

3. The method of claim 1, further comprising:
for each tone in each tone group, determining a number of bits allocated to the tone based at least on the SNR margin for the tone; and
communicating allocation information describing the determined number of bits allocated to each tone to the transmitter, wherein the transmitter loads bits for transmission by way of the tones based at least on the allocation information.

4. The method of claim 1, further comprising forming the plurality of tone groups in a manner that equalizes a group SNR margin amongst the tone groups.

5. The method of claim 4, further comprising determining the group SNR for each group based at least on a square root of a product of the SNR margin for a first tone in the tone group and the SNR margin for a second tone in the tone group.

6. The method of claim 1, further comprising, after communicating the ordering information to the transmitter:
measuring a second SNR margin for each tone; and
when a threshold based at least on SNR margin is met:
determining a second plurality of tone groups by, for each tone group, grouping at least one tone with a relatively high second SNR margin with at least one tone with a relatively low second SNR margin to form a new tone group; and
communicating second ordering information describing the plurality of new tone groups to the transmitter.

7. The method of claim 6, further comprising determining whether the threshold is met by:
determining a group SNR margin for each tone group based at least on the second SNR margin for each tone;
identifying, from amongst the group SNR margins for the tone groups, a minimum group SNR margin and a maximum group SNR margin;
comparing the minimum group SNR margin to a minimum threshold;
determining that the threshold has been met when the minimum group SNR margin is less than the minimum threshold;
comparing the maximum group SNR margin to a maximum threshold; and
determining that the threshold has been met when the maximum group SNR margin is less than the maximum threshold.

8. A transceiver, comprising:
a receiver comprising determination circuitry configured to:
measure a respective signal-to-noise-ratio (SNR) margin for each respective tone in a multicarrier channel;
determine a plurality of tone groups by, for each tone group, grouping at least one tone with a relatively high SNR margin with at least one tone with a relatively low SNR margin to form a tone group; and
a transmitter configured to transmit tone ordering information describing the plurality of tone groups to a second transceiver, wherein the second transceiver is configured to load bits for transmission to the receiver based at least on the ordering information.

9. The transceiver of claim 8, wherein the tones are assigned respective integer tone indices and the determination circuitry is configured to, until all tones have been grouped:
select, from tones having even indices, first tone having a minimum SNR margin;
select, from tones having odd indices, an second tone having a maximum SNR margin;
group the first tone with the second tone to form a new tone group; and
eliminate the first tone and the second tone from consideration.

10. The transceiver of claim 8, wherein:
the determination circuitry is further configured to for each tone in each tone group, determine a number of bits allocated to the tone based at least on the SNR margin for the tone; and
the transmitter is configured to transmit allocation information describing the determined number of bits allocated to each tone to the transceiver, wherein the transceiver loads bits for transmission to the receiver by way of the tones based at least on the allocation information.

11. The transceiver of claim 8, wherein the determination circuitry is further configured to form the plurality of tone groups in a manner that equalizes a group SNR margin for each tone group.

12. The transceiver of claim 11, wherein the determination circuitry is further configured to determine the group SNR for each group based at least on a square root of a product of the SNR margin for a first tone in the tone group and the SNR margin for a second tone in the tone group.

13. The transceiver of claim 8, wherein the determination circuitry is further configured to, after the transmitter transmits the tone ordering information to the transmitter:
measure a second SNR margin for each tone; and
when a threshold based at least on SNR margin is met:
determine a second plurality of tone groups by, for each tone group, grouping at least one tone with a relatively high second SNR margin with at least one tone with a relatively low second SNR margin to form a new tone group;
communicate second ordering information describing the plurality of new tone groups to the transmitter for transmission to the transceiver.

14. The transceiver of claim 8, wherein the determination circuitry is further configured to determine whether the threshold is met by:
determining a group SNR margin for each tone group based at least on the second SNR margin for each tone;
identifying, from amongst the group SNR margins for the tone groups, a minimum group SNR margin and a maximum group SNR margin;
comparing the minimum group SNR margin to a minimum threshold;
determining that the threshold has been met when the minimum group SNR margin is less than the minimum threshold;
comparing the maximum group SNR margin to a maximum threshold; and
determining that the threshold has been met when the maximum group SNR margin is less than the maximum threshold.

15. Computer readable media having computer-executable instructions stored thereon that, when executed by a processor, cause the processor to perform corresponding functions, the instructions comprising instructions for:
measuring a respective signal-to-noise-ratio (SNR) margin for each respective tone in a multicarrier channel;
determining a plurality of tone groups by, for each tone group, grouping at least one tone with a relatively high SNR margin with at least one tone with a relatively low SNR margin to form a tone group; and
communicating ordering information describing the plurality of tone groups to a transmitter, wherein the transmitter is configured to load bits for transmission by way of the tones based at least on the ordering information.

16. The computer readable media of claim 15, wherein the tones are assigned respective integer tone indices and wherein the instructions for grouping comprise instructions for, until all tones have been grouped:
selecting, from tones having even indices, first tone having a minimum SNR margin;
selecting, from tones having odd indices, an second tone having a maximum SNR margin;
grouping the first tone with the second tone to form a new tone group; and
eliminating the first tone and the second tone from consideration.

17. The computer readable media of claim 15, wherein the instructions further comprise instructions for:
for each tone in each tone group, determining a number of bits allocated to the tone based at least on the SNR margin for the tone; and
communicating allocation information describing the determined number of bits allocated to each tone to the transmitter, wherein the transmitter loads bits for transmission by way of the tones based at least on the allocation information.

18. The computer readable media of claim 15, wherein the instructions comprise instructions for forming the plurality of tone groups in a manner that equalizes a group SNR margin for each tone group.

19. The computer readable media of claim 18, wherein the instructions comprise instructions for determining the group SNR for each group based at least on a square root of a product of the SNR margin for a first tone in the tone group and the SNR margin for a second tone in the tone group.

20. The computer readable media of claim 15, wherein the instructions comprise instructions for, after communicating the ordering information to the transmitter:
measuring a second SNR margin for each tone; and
when a threshold based at least on SNR margin is met:
determining a second plurality of tone groups by, for each tone group, grouping at least one tone with a relatively high second SNR margin with at least one tone with a relatively low second SNR margin to form a new tone group; and
communicating second ordering information describing the plurality of new tone groups to the transmitter.

21. The computer readable media of claim 20, wherein the instructions for determining whether the threshold is met comprise instructions for:
determining a group SNR margin for each tone group based at least on the second SNR margin for each tone;
identifying, from amongst the group SNR margins for the tone groups, a minimum group SNR margin and a maximum group SNR margin;
comparing the minimum group SNR margin to a minimum threshold;
determining that the threshold has been met when the minimum group SNR margin is less than the minimum threshold;
comparing the maximum group SNR margin to a maximum threshold; and
determining that the threshold has been met when the maximum group SNR margin is less than the maximum threshold.
